(19) United States
(12) Patent Application Publication
(10) Pub. No.: US 2002/0041228 A1
(43) Pub. Date: Apr. 11, 2002

(54) Apparatus for power line computer network system

(76) Inventor: George Zhang, San Mateo, CA (US)

Correspondence Address: Harris Zimmerman, Law Offices of Harris Zimmerman, Suite 710, 1330 Broadway, Oakland, CA, 94612-2506, US

(21) Appl. No.: 09/854,450

(22) Filed: May 14, 2001

Related U.S. Application Data
(63) Continuation of application No. 09/686,436, filed on Oct. 10, 2000.

(51) Int. Cl. H04M 11/04

(52) U.S. Cl. 340/310.01; 340/310.06

(57) ABSTRACT

A multi-point computer networking system for transmitting data over power lines is built into a computer. The networking system includes a bus interface unit for exchanging data with a computer, a power line data transceiver unit for placing data onto and taking data off of the power line, and a network controller implementing a network protocol for sending and receiving messages. The networking system shares the main power cord with the computer. Therefore, only one power cord is needed for each computer to serve both AC power and data networking functions.

### REFERENCE TO RELATED APPLICATION

This application is a continuation of application Ser. No. 09/686,436, filed Oct. 10, 2000, for which priority is claimed.

### BACKGROUND OF THE INVENTION

The present invention relates in general to a computer networking system. More particularly, the present invention is an apparatus for providing networking capability to a computer station via its main AC power cord. The present invention also relates to a power line communication (PLC) network system.

A computer network includes a number of computers, printers, or other peripheral equipment (devices) that are linked together so as to permit individual devices to exchange data with one or more other devices on the network. Historically, the devices of a computer network have been linked together by dedicated wires. However, dedicated wiring has many drawbacks, such as high cost, inconvenience and installation difficulty, especially when expanding or reconfiguring the network system in existing buildings. So other alternative approaches have been developed for network communications media such as wireless and AC power lines.

In power line communications (PLC), network data is transmitted on an existing power line in addition to the electrical AC line current already present for delivering electrical power. Using the power line as the medium for communications is particularly convenient because a power line will always be present to provide AC power to the various devices on a network. A number of PLC protocols (such as: X-10, CEBus, Lonworks and PowerPacket) have been developed, and chip sets employing them are commercially available, making the AC power line a feasible network communications medium.

There are a number of PLC patents issued. For example, U.S. Pat. No. 4,809,296 shows a structure of a PLC system using one kind of modulation scheme. However, it does not show how to implement the scheme as a network device. U.S. Pat. No. 5,684,826 shows how to build a RS-485 power line modem for data networks, but it does not show the application for commercial and personal computer devices. Moreover, RS-485 is an industrial communication scheme that is not suitable for commercial and personal computer applications, and the speed is too slow for computer local area network (LAN) applications such as Ethernet.

There are some PLC products that have been introduced commercially. For example, “PassPort” is built by Intelogis Inc., of Draper, Utah. It is a low speed (350 Kbps) wall plug-in PLC device which requires an external parallel cable to connect to a personal computer. This provides no advantage over a regular LAN system since they both require two separate cables (an AC power cord and a data cable).

### SUMMARY OF THE INVENTION

In order to take the advantage of single cord solution for a PLC network system, the present invention provides an apparatus of a PLC network system integrated into a computer system. The PLC networking system is in conjunction with a switched power supply, as used in a normal computer system. The PLC networking system contains an EMI isolator, a power line data transceiver, a network controller and a bus interface.

Accordingly, several objects and advantages of my present invention are (1) By combining the PLC networking system with a computer station, the external data cable is eliminated, thereby requiring only a single main power cord for each networked computer. (2) The PLC networking system is able to obtain DC power from the computer's main power supply, thereby reducing both the cost and size of the networking system. (3) Combining the PLC networking system with a computer station will achieve higher system integration, thereby eliminating extra hardware installation by the end user. (4) Because the PLC networking system is built inside a computer and shares the same AC power cord, electromagnetic interference (EMI) noise can be blocked by inserting an EMI isolator to improve the quality and throughput of data communications.

### BRIEF DESCRIPTION OF THE DRAWING

FIG. 1 is a functional block diagram showing a PLC network system for a computer system in accordance with the present invention.

FIG. 2A is a functional block diagram showing details of the PLC network system depicted in FIG. 1.

FIG. 2B is a functional block diagram showing an improved design of the PLC network system in FIG. 2A.

FIG. 3 is a functional block diagram showing details of the EMI isolator and data transceiver of the PLC network depicted in FIGS. 2A and 2B.

### DESCRIPTION OF THE PREFERRED EMBODIMENT

The present invention generally comprises a multi-point computer networking system built into a computer for transmitting data over power lines. The networking system includes a bus interface unit for exchanging data with a computer, a power line data transceiver unit for placing data onto and taking data off of the power line, and a network controller implementing a network protocol for sending and receiving messages. The networking system shares the main power cord with the computer. Therefore, only one power cord is needed for each computer to serve both AC power and data networking functions.

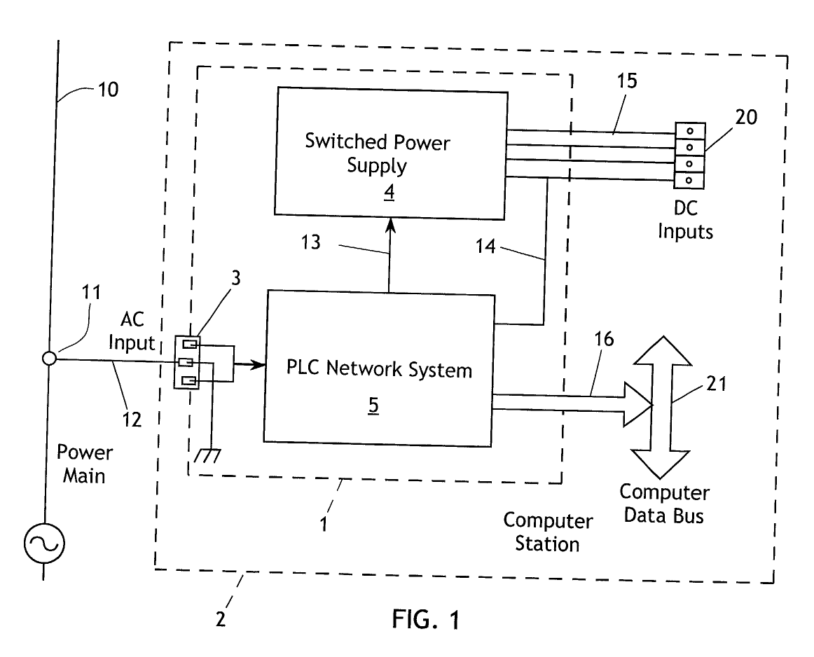

FIG. 1 shows a block diagram of PLC computer network system. A PLC network system 5 and a switched power supply 4 act in conjunction as a power-network module 1 to serve a computer station 2. A power line 10 is commonly found in commercial, industrial or residential buildings. Power line 10 may also be provided, for example, by a system of temporary power lines or extension cords such as might be set up at a trade show or exhibition for supplying electrical power to a number of computers, printers, or other peripheral equipment.

PLC network system 5 is connected to power line 10 through a conventional AC input socket 3, AC power cord 12 and AC power outlet box 11. The PLC network system 5 also connects to a computer data bus 21 in a computer station 2 via a matched type base-band data cable 16. The PLC network system 5 distributes the main AC power to a switched power supply 4 via AC input cable 13. The switched power supply 4 provides the operating DC power to a computer motherboard DC input 20 in the computer station 2 via a set of DC power cables 15. The switched power supply 4 also provides the operating DC power to the PLC network system 5 via a DC distribution cable 14.

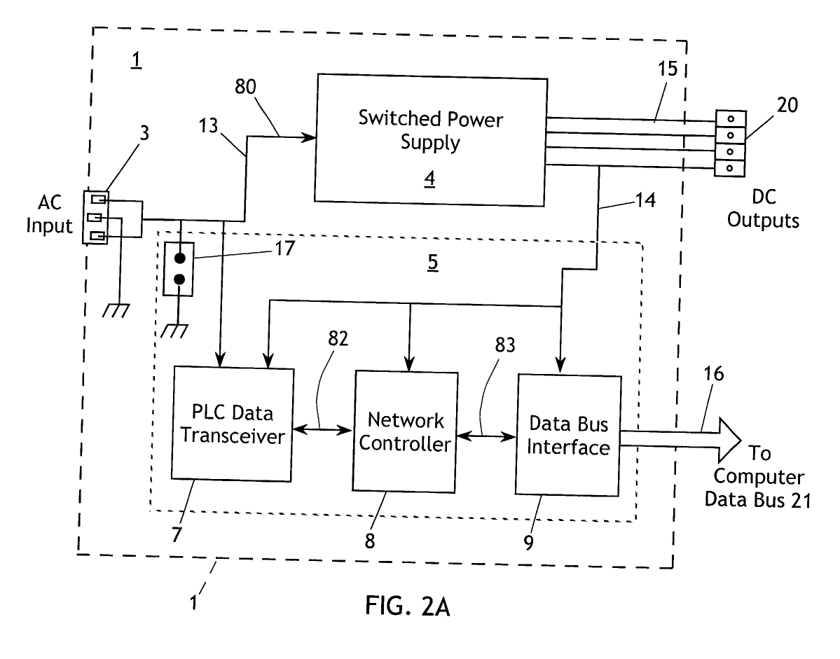

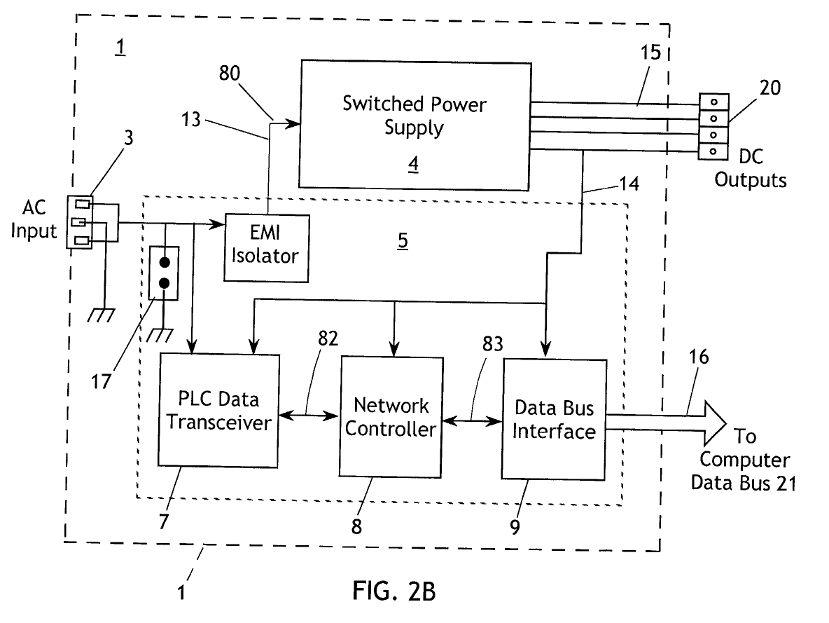

FIG. 2A shows a functional block diagram of an embodiment of PLC network system 5, in which the network system 5 is comprised of a PLC data transceiver 7 connected to a network controller 8, which in turn is connected to a data bus interface 9.

FIG. 2B shows a improved design of the PLC network system 5, including an electromagnetic interference (EMI) isolator 6, a PLC data transceiver 7, a network controller 8, and a data bus interface 9. EMI isolator 6 is connected between the AC input 3 and the switched power supply 4. The particular manner in which the power line data transceiver is connected to the power line is important because the PLC signal on the power line is transferred through same power cord shared with a regular switched power supply 4. A typical switched power supply generates significant high frequency electromagnetic interference (EMI) noise 80, especially inside a computer enclosure, and the EMI noise, if unabated, will be transfer to the AC power input and to the PLC network system 5. The frequency range of this EMI noise is in the range of several kilohertz to several megahertz. It may interfere with the PLC signal, especially in high speed PLC systems. The result may be distortion of the PLC signal, causing a high bit-error-rate (BER), a slowdown of data throughput, and even a jam of the communication channel (which is the power line). The EMI isolator 6 is designed to block signals higher than 500 Hz, and alleviates this potential problem.

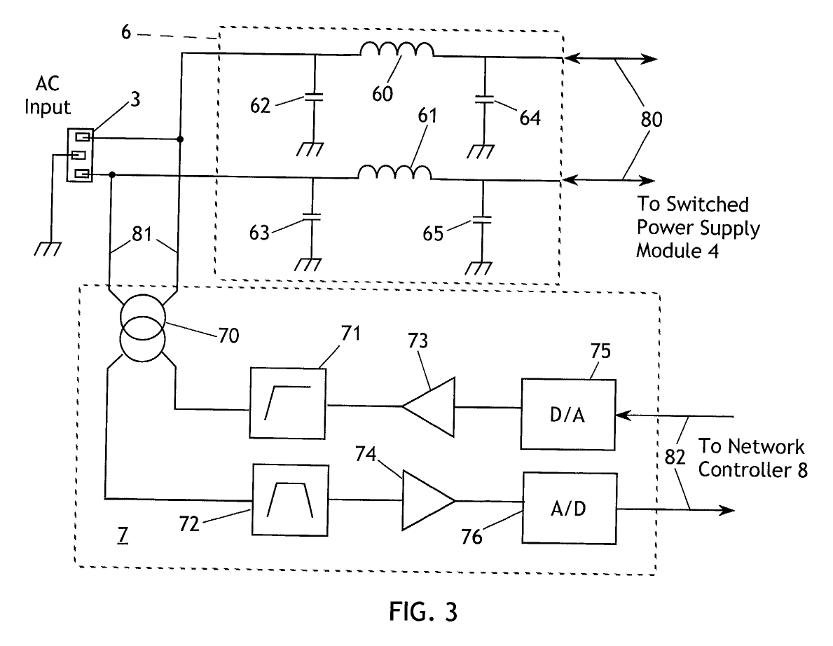

FIG. 3 shows the detail structure of the EMI isolator 6. In general, the EMI isolator 6 is an LC low-pass filter. The LC low-pass filter contains two inductors 60 and 61 connected to capacitors 62 and 64, and 63 and 65, respectively, to form a dual Pi-type LC low-pass filter. Alternatively, in order to reduce the size and cost of the PLC network system 5, the filter may comprise only one inductor 60 and one capacitor 62 as an L-type LC filter. The capacitors may receive surges from the AC power main, so the working voltage of the capacitors should be at least 500 V. Also a surge protector 17 (showing in FIGS. 2A and FIG. 2B) is added at main AC power input near AC input socket 3 to protect internal electrical circuitry. Since a high current will be passing through the inductors, the coil of the inductors should handle at least 10 A of continuous current, with peak current greater than 50 A. Magnetic type inductors may be used in order to reduce the size of the EMI isolator 6.

The PLC data transceiver 7 transmits and receives the PLC signal 81. FIG. 3 shows the components of PLC data transceiver 7, including a PLC signal coupler 70, a low-pass filter 71, a band-pass filter 72, a transmitter amplifier 73, a receiver amplifier 74, a digital to analog converter 75, and an analog to digital converter 76. Since there are many commercial power line data transceivers modules available from multiple vendors, the structures, circuitry and principles are well known from other methods and thus need not be described in detail here.

A 32 bit RISC microcontroller is used to implement both network controller 8 and data bus interface 9. Network controller 8 (FIGS. 2A-2B) is a part of the RISC microcontroller functions that is implemented by firmware. The network controller 8 is responsible for implementing the network protocols for sending and receiving messages via a computer network.

Data bus interface 9 also is a part of the RISC microcontroller functions, which is also implemented by firmware. The RISC microcontroller has two universal synchronous/asynchronous receiver/transmitter (USART) ports. A software module simulates the function of a universal serial bus (USB) port through one of the USART ports. The simulated USB port is directly connected to the computer data bus 21 (USB port) in the computer station 2 through an internal USB data cable 16, as shown in FIG. 1.

### PREFERRED EMBODIMENT—OPERATION

The PLC network system 5 performs the networking function that covers the OSI seven-layer model from layer 1 to layer 4. The PLC data transceiver 7 handles layer 1; e.g., the physical layer function. The network controller 8 handles layer 2, the link layer; layer 3, the network layer; and layer 4, the transport layer. The network controller 8 performs data link control, such as framing, data transparency, error control, network routing, addressing, call setup/clearing, and end-to-end message transfer such as connection management, error control, fragmentation, flow control, etc.

When the computer station 2 has a network data packet which needs to be sent to other stations, it will put the network data packet on the computer data bus 21, and then transfer it to the data bus interface 9 via data cable 16. The data bus interface 9 buffers the data packet and transfers a network signal 83 to the network controller 8. The network controller 8 assembles a necessary overhead of networking control bits to the body of the data packet. Then the data packet is modulated by the RISC microcontroller. The digital to analog converter 75 (FIG. 3) takes the modulated digital signal 82 and converts it to a PLC signal 81 which goes through transmitter amplifier 73, low-pass filter 71 and the PLC signal coupler 70. Finally, the PLC signal 81 is placed onto the power line 10.

For incoming signals, the PLC signal coupler 70 receives a PLC signal 81 from power line 10, and the signal goes through band-pass filter 72, receiver amplifier 74 and analog to digital converter 76 which converts it to the digital signal 82. Then the digital signal is demodulated by the RISC microcontroller which also de-assembles the networking control bits by network controller 8. Then the network signal 83 goes through the data bus interface 9 to the computer data bus 21.

### CONCLUSION, RAMIFICATIONS, AND SCOPE

Accordingly, it can be seen that the PLC network system of this invention can be used for commercial and personal computers to provide computer networking via power lines. The PLC network system is embedded within a computer enclosure, so that it is able to share a single main power cord for both AC power input as well as exchanging data with other devices on a computer network. Because the PLC network system does not require an external data cable, the networking installation is very simple: just plug the computer's power cord into the AC wall outlet, turn on the power, and the computer is immediately connected to the network.

The embedded PLC network system has additional advantages in that:

It reduces the base-band noise level at the data bus side because the data cable is shorter.

It reduces the noise level at PLC data transceiver side because the EMI filter blocks the noise emanating from the switched power supply.

It reduces cost and size by eliminating the external data cable and by using DC power from the computer switched power supply (a necessary computer component system) as its operating power source.

It provides a highly integrated single cord solution for networking by offering simple installation without extra cables and hardware.

Although the description above contains many specifics, these should not be construed as limiting the scope of the invention but as merely providing illustrations of some of the presently preferred embodiments of this invention. For example, (1) the bus interface will support any other kind of bus, such as ISA bus, PCI bus, IDE bus, SCSI bus, etc. It also will support other kinds of communication ports, such as any parallel port or any serial port. It also can be a special type of bus that directly connects to a data communication chipset on the computer motherboard or a plug-in PC card. (2) The electronic circuitry of the PLC network system can be installed physically anywhere inside a computer enclosure, or as an attachment to the computer enclosure, or as an attachment inside or outside of the AC input socket on the computer. It also may be a part of a computer module, such as a part of the power supply; a part of the motherboard; or a part of a plug-in PC card, etc. (3) The system may draw operating power from the computer main power supply, but alternatively may also be self-powered, if necessary.

Thus the scope of the invention should be determined by the appended claims and their legal equivalents, rather than by the examples given.

1. A power line communication network system for a computer system having a data bus, including:
a power line communication data transceiver;
means for connecting said data transceiver to an AC power line for bidirectional data communications;
a network controller connected to said data transceiver, said network controller adapted to receive an incoming signal forwarded from said data transceiver and to transfer said incoming signal to the data bus of the digital system.

2. The power line communication network system of claim 1, wherein said means for connecting said data transceiver further includes an electromagnetic interference isolator to prevent electromagnetic interference noise from affecting said power line communication data transceiver.

3. The power line communication network system of claim 1, wherein said data bus interface is connect ed to a data exchanging component within a computer station.

4. The power line communication network system of claim 2, wherein said means for connecting said data transceiver to an AC power line includes an AC input socket.

5. The power line communication network system of claim 4, wherein said electromagnetic interference isolator is connected at a circuit point between said AC input socket and said data transceiver.

6. The power line communication network system of claim 4, further including a DC power supply connected to said AC input socket.

7. The power line communication network system of claim 6, wherein said electromagnetic interference isolator is connected between said AC input socket and said DC power supply.

8. The power line communication network system of claim 7, wherein said DC power supply comprises a switched power supply.

9. The power line communication network system of claim 2, wherein said electromagnetic interference isolator includes a low-pass LC filter.

10. The power line communication network system of claim 9, wherein said low-pass LC filter includes at least one inductor connected in a Pi-type filter arrangement.

11. The power line communication network system of claim 9, wherein said low-pass LC filter includes a pair of inductors, each connected to a respective pair of capacitors to form a dual Pi-type filter arrangement.

12. The power line communication network system of claim 9, wherein said low-pass LC filter includes at least one inductor connected in a L-type filter arrangement.

13. The power line communication network system of claim 1, wherein said data transceiver includes means for dual channel data transmission.

14. The power line communication network system of claim 13, wherein an incoming signal channel of said data transceiver includes a PLC signal coupler connected to the AC line input, and a band-pass filter connected to said signal coupler.

15. The power line communication network system of claim 14, further including an analog/digital converter connected to the output of said band-pass filter, the output of said analog/digital converter being connected to said network controller.

16. The power line communication network system of claim 13, wherein an outgoing signal channel of said data transceiver includes a digital/analog converter for receiving signals from said network controller, and a low pass filter for receiving signals from said digital/analog converter.

17. The power line communication network system of claim 16, wherein the output of said low pass filter is connected to a PLC signal coupler, and the output of said PLC signal coupler is connected to the AC power line.

18. The power line communication network system of claim 1, wherein said data transceiver, said means for connecting, and said network controller are all installed within the computer system enclosure.

19. The power line communication network system of claim 18, wherein the computer system includes a switched power supply, and said data transceiver is connected to receive operating power from said switched power supply.

20. The power line communication network system of claim 19, further including an electromagnetic noise isolator connected between said data transceiver and said switched power supply.
